(19) United States
(12) Patent Application Publication
(10) Pub. No.: US 2012/0170497 A1
(43) Pub. Date: Jul. 5, 2012

(54) METHOD FOR REPORTING SRS IN DISCONTINUOUS RECEPTION AND WIRELESS COMMUNICATION SYSTEM THEREOF

(75) Inventors: YUANYUAN ZHANG, Beijing City (CN); Tsung-Liang Lu, Taipei City (TW)

(73) Assignee: HT mMobile Inc., Hsinchu (TW)

(21) Appl. No.: 13/341,173

(22) Filed: Dec. 30, 2011

Related U.S. Application Data
(60) Provisional application No. 61/429,584, filed on Jan. 4, 2011.

(51) Int. Cl. H04W 52/02; H04W 4/00

(52) U.S. Cl. 370/311; 370/328

(57) ABSTRACT

This invention relates to a method for reporting SRS in discontinuous reception and a wireless communication system thereof. The wireless communication system includes a user equipment (UE), a serving cell and a base station. The UE is for transmitting a periodic Sounding Reference Signal (SRS) and an aperiodic SRS, wherein the UE monitors a PDCCH in an active time. The serving cell has a serving range, wherein the UE is in the serving range of the serving cell. The base station is for performing connection to the UE and serving the serving cell. The UE transmits the aperiodic SRS no matter whether UE is in active time or not when the UE has been triggered to report the aperiodic SRS by a SRS request from the base station.

This application claims the benefit of U.S. Provisional Application No. 61/429,584 filed on Jan. 4, 2011, the content of which is hereby incorporated by reference.

### BACKGROUND OF THE INVENTION

1. Field of Invention

The present invention relates in general to a Sounding Reference Signal transmission, and more particularly to an aperiodic Sounding Reference Signal transmission during Discontinuous Reception in a wireless communication system.

2. Related Art

In a wireless communication system, how to efficiently distribute/allocate uplink transmission resources between multiple user equipments (UEs) is always a critical issue from the system point of view. In order to achieve better resource scheduling, some mechanisms which is used for enabling UEs to provide related information to inform the network side of the quality of the channel, are usually introduced in the wireless communication system. For example, a Sounding Reference Signal (SRS) is introduced in the 3rd Generation Partnership Project (3GPP) Evolved UTRA (E-UTRA) system.

The SRS is transmitted on the uplink to the network side and the network side can estimate the quality of the uplink channel to a specific UE by the SRS. The SRS would be transmitted according to corresponding configuration, wherein the SRS would be transmitted in the last symbol of a subframe.

In release 8 and release 9 (Rel-8/Rel-9) 3GPP E-UTRA systems, a periodic SRS transmission is designed. However, in order to satisfy high peak data rate requirements, designs such as up to 4×4 antenna configurations and spatial multiplexing with up to four layers are supported in release 10 E-UTRA system. The current SRS reporting mechanism in release 8 and release 9 is designed for the single antenna transmission. To satisfy the requirement of new scenarios in release 10 such as Carrier Aggregation (CA) and enhanced Uplink (UL) Multi-input Multi-output (MIMO), the SRS requirement will increase dramatically, i.e. more SRS reporting is required for accurate channel estimation.

### SUMMARY OF THE INVENTION

It is therefore a first objective of the present invention to provide a wireless communication system, so that the eNB can obtain instantaneous channel condition.

It is therefore a second objective of the present invention to provide a method for reporting SRS in discontinuous reception for accurate channel estimation, so that the radio resource can be allocated appropriately.

In order to achieve the abovementioned first object of the present invention and other object of the present invention, a wireless communication system is provided. The wireless communication system includes a user equipment, a serving cell and a base station. The user equipment is for transmitting a periodic Sounding Reference Signal (SRS) and an aperiodic SRS, wherein the user equipment monitors PDCCH in an active time. The serving cell has a serving range, wherein the user equipment is in the serving range of the serving cell. The base station is for performing connection to the user equipment and serving the serving cell. The UE transmits the aperiodic SRS no matter whether UE is in active time or not when the UE has been triggered to report the aperiodic SRS by a SRS request from the base station.

In order to achieve the abovementioned second object of the present invention and other object of the present invention, a method for reporting SRS in discontinuous reception is provided. The method includes the steps of: providing a user equipment for transmitting a periodic Sounding Reference Signal (SRS) and an aperiodic SRS; transmitting the periodic SRS and aperiodic SRS by the UE when the UE is in a serving range of a serving cell; monitoring a Physical Downlink Control Channel (PDCCH) of the serving cell by the UE when the UE is in an active time; transmitting a SRS request for triggering the UE to report the aperiodic SRS; and reporting the aperiodic SRS no matter UE is in active time or not when the UE has been triggered to report the aperiodic SRS.

In a preferred embodiments of the present invention, the active time comprises: a time when an onDurationTimer is running; or a time when a drx-InactivityTimer is running; or a time when a drx-RetransmissionTimer is running, wherein the onDurationTimer specifies the number of consecutive PDCCH-subframe(s) at the beginning of a discontinuous reception (DRX) Cycle, wherein the drx-InactivityTimer specifies the number of consecutive PDCCH-subframe(s) after successfully decoding a physical downlink control channel (PDCCH) indicating an initial uplink or downlink user data transmission for the corresponding user equipment thereof, wherein the drx-RetransmissionTimer specifies the maximum number of consecutive PDCCH-subframe(s) for as soon as a downlink retransmission is expected by the corresponding user equipment thereof.

In a preferred embodiments of the present invention, the active time comprises: a time when a mac-ContentionResolutionTimer is running, wherein the mac-ContentionResolutionTimer specifies the number of consecutive subframe(s) during which the corresponding user equipment thereof shall monitor the physical downlink control channel (PDCCH) after a Msg3 is transmitted, wherein the Msg3 specifies a message transmitted on UL-SCH containing a C-RNTI MAC CE or CCCH SDU, submitted from upper layer and associated with the UE Contention Resolution Identity, as part of a random access procedure.

In a preferred embodiments of the present invention, the active time comprises: a time when a Scheduling Request is sent on a physical uplink control channel (PUCCH) and is pending; or a time when an uplink grant for a pending HARQ retransmission can occur and there is data in the corresponding HARQ buffer; or a time when PDCCH indicating a new transmission addressed to the C-RNTI of the UE has not been received after successful reception of a Random Access Response for the preamble not selected by the corresponding user equipment thereof.

In a preferred embodiments of the present invention, the above-mentioned serving cell is a primary cell and the wireless communication system further comprises a secondary cell, wherein UE would report the aperiodic SRS through the primary cell if the aperiodic SRS for the primary cell has been triggered to be reported, and UE would report the aperiodic SRS through the secondary cell if the aperiodic SRS for the secondary cell has been triggered to be reported.

In the present invention, since the aperiodic SRS is reported by the UE both in active time and non-active time, the base station can obtain instantaneous channel condition information. Also, the network can allocate the radio resource accordingly.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention.

FIG. 1 illustrates the DRX cycle according to an embodiment of the present invention.

FIG. 2 illustrates a wireless communication system according to an embodiment of the present invention.

FIG. 3 illustrates a subframe and the time slot structure according to an exemplary embodiment of the present invention.

FIG. 4 illustrates a flowchart depicting the method for reporting SRS in discontinuous reception according to an embodiment of the present invention.

FIG. 5 illustrates a flowchart depicting the method for reporting aperiodic SRS in discontinuous reception according to fourth embodiment of the present invention.

FIG. 6 illustrates a flowchart depicting the method for reporting periodic SRS in discontinuous reception according to fourth embodiment of the present invention.

FIG. 7 illustrates a flowchart depicting the method for reporting periodic SRS in discontinuous reception according to fourth embodiment of the present invention.

### DETAILED DESCRIPTION OF THE INVENTION

The present invention will be apparent from the following detailed description, which proceeds with reference to the accompanying drawings, wherein the same references relate to the same elements.

In wireless communication system, a user equipment (UE) adopts Discontinuous Reception (DRX) mechanism for reducing power consumption. To take current 3GPP E-UTRA system for example, the UE is allowed not to continuously monitor a Physical Downlink Control Channel (PDCCH) when the UE is configured by Radio Resource Control (RRC) with DRX functionality in RRC_CONNECTED state. The time that the UE should monitor PDCCH is defined as Active Time. When the UE is not in an active time, monitoring the PDCCH and performing blind decoding by UE are unnecessary such that the power consumption would be reduced.

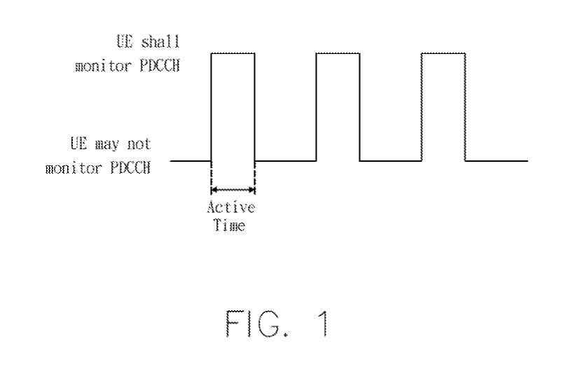

In an 3GPP LTE (Long Term Evolution) system, when the LTE base station (eNode B, eNB) allocates a radio resource to a specific UE to let the specific UE transmit and/or receive the control message, the specific UE can monitor the PDCCH discontinuously using the DRX operation for power saving The mechanism combines the timer and DRX cycle such that the eNB and UE would have the same DRX configuration. When a downlink data to be transmitted, the eNB can precisely determine whether the UE is available to receive data. The DRX timing may be shown in FIG. 1. FIG. 1 illustrates the DRX timing according to an embodiment of the present invention. Referring to FIG. 1, the higher level shown in FIG. 1 refers to the active time, where UE shall monitor a PDCCH, the lower level shown in FIG. 1 refers to the non-active time, where UE would not monitor the PDCCH. The system can set different DRX parameters according to different requirement of application so as to balance the data latency and the power consumption. In the current agreed DRX mechanism, the Active Time is mainly determined by several relevant timers and/or whether some conditions are fulfilled 3GPP TS 36.321 v10.0.0 in sub-clause 3.1 and 5.7.

When a DRX cycle is configured, the Active Time includes the time of:

1. the time when an onDurationTimer is running, wherein the onDurationTimer specifies the number of consecutive PDCCH-subframe(s) at the beginning of a DRX Cycle;

2. the time when a drx-InactivityTimer is running, wherein the drx-InactivityTimer specifies the number of consecutive PDCCH-subframe(s) after successfully decoding a physical downlink control channel (PDCCH) indicating an initial uplink or downlink user data transmission for the corresponding user equipment thereof;

3. the time when a drx-RetransmissionTimer is running, wherein the drx-RetransmissionTimer specifies the maximum number of consecutive PDCCH-subframe(s) for as soon as a downlink retransmission is expected by the corresponding user equipment thereof;

4. the time when a mac-ContentionResolutionTimer is running, wherein the mac-ContentionResolutionTimer specifies the number of consecutive subframe(s) during which the corresponding user equipment thereof shall monitor the physical downlink control channel (PDCCH) after a Msg3 is transmitted, wherein the Msg3 specifies a message transmitted on UL-SCH containing a C-RNTI MAC CE or CCCH SDU, submitted from upper layer and associated with the UE Contention Resolution Identity, as part of a random access procedure;

5. the time when a Scheduling Request is sent on a physical uplink control channel (PUCCH) and is pending;

6. the time when an uplink grant for a pending HARQ retransmission can occur and there is data in the corresponding HARQ buffer;

7. the time when a PDCCH indicating a new transmission addressed to the C-RNTI of the UE has not been received after successful reception of a Random Access Response for the preamble not selected by the corresponding user equipment thereof.

### The First Embodiment

In the disclosure, a wireless communication system will be described, and an operation of the wireless communication system may be performed in a base station and a mobile station (MS) to administer the network and transmit data, system information, control signals, etc. For conveniently describing the present invention, the 3GPP LTE system is taken as an example in the following first embodiment, however, the wireless communication system provided in the present invention is not limited thereto. The base station may be served as eNode B (eNB), and the mobile station (MS) includes at least a UE.

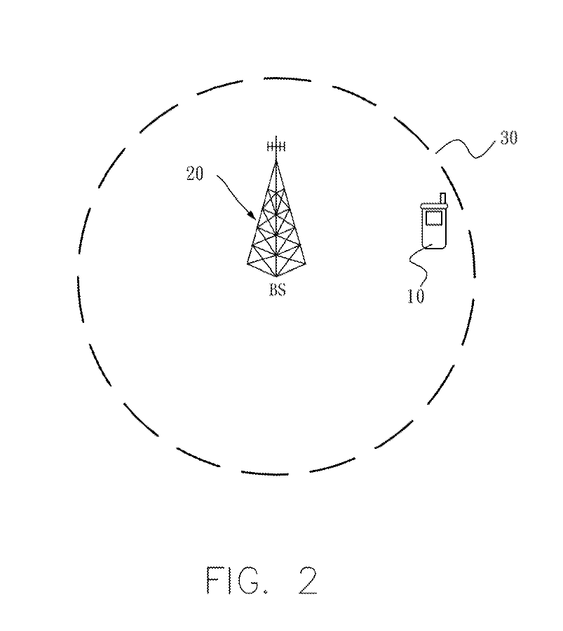

FIG. 2 illustrates a schematic diagram of a wireless communication system according to an embodiment of the present invention. Referring to FIG. 2, the wireless communication system is for example to include UE 10 and an eNB 20. Periodic or aperiodic SRS transmission technology may be applied to the UE 10 and the eNB 20. The eNB serves the serving cell 30, and the UE 10 monitor a PDCCH through the serving cell 30. Due to DRX is configured, the UE is permitted only to monitor the PDCCH in active time.

In the wireless communication system to which the embodiments are applied, one radio frame may include 10 subframes, and one subframe may include two slots. One slot may include a plurality of OFDM symbols in the time domain.

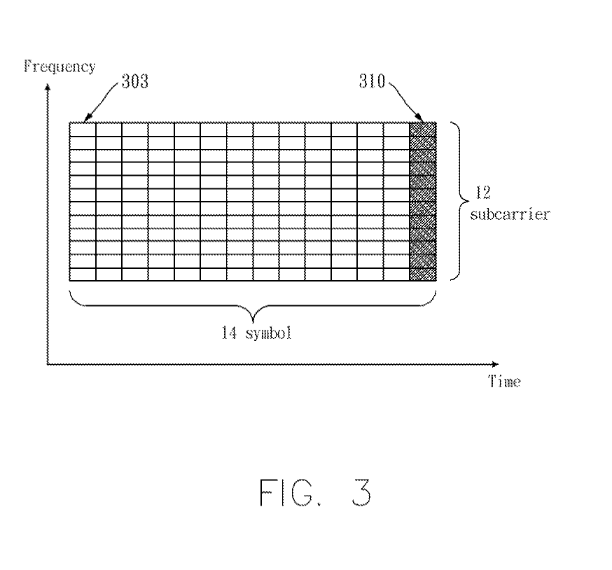

A basic unit for data transmission is a subframe, and the scheduling of downlink or uplink may be performed for each subframe. For example, a subframe may include two slots, and each of the slots may include 7 OFDM symbols in the time domain. FIG. 3 illustrates a subframe and the time slot structure according to an exemplary embodiment, and the subframe includes 14 symbols 303 in the time domain. However, an embodiment of the present invention is not limited to the subframe and the time slot structure shown in FIG. 3.

A UE sends an SRS (i.e., a reference signal for an uplink channel estimation) to an eNB in order to provide uplink channel information to the eNB. The SRS, in this case, has a similar function to a pilot channel. In this specification hereinafter, an SRS which is an example of a channel estimation reference signal is disclosed.

In addition, the SRS is to provide uplink channel estimation reference about an available band to the eNB. That is, an SRS for all subcarrier bands or an SRS for a subcarrier band in which data information is primarily transmitted may have to be transmitted. The SRS may be transmitted in the last symbol of each subframe, or every several subframes according to corresponding configuration. In FIG. 3, the SRS (labeled as 310) is transmitted in the last symbol of the subframe. According to the SRS configuration by a higher layer, an SRS can be periodically transmitted for each cell (or eNB) or for each radio frame or transmission cycle. In the embodiment, when a periodic SRS is configured by upper layers, the UE will transmit the SRS periodically. Since a DRX cycle is configured, the periodic SRS may not be reported when the UE is not in active time.

For more accurate channel estimation, the channel reference signal is needed to report more dynamically. An aperiodic SRS is introduced in the embodiment. When a SRS request is transmitted from the eNB 20 to the UE 10, the UE 10 is triggered to report the aperiodic SRS, wherein the SRS request may be transmitted through a control channel, for example the PDCCH, but not limited thereto. Then, the UE 10 will report the aperiodic SRS regardless of whether the UE 10 is in active time or not in the next available subframe which is configured by higher layer to carry the aperiodic SRS. However, if both the aperiodic SRS and the periodic SRS transmissions occur in the same subframe, the UE 10 only transmits the aperiodic SRS.

### The Second Embodiment

In the following embodiment, the wireless communication system is similar to the wireless communication system described in the abovementioned embodiment. Therefore, the same part would be omitted in the second embodiment. Since the abovementioned embodiment already provided the periodic SRS transmission mechanism, the description of the periodic SRS transmission mechanism would be also omitted in the second embodiment.

In order to increase the transfer rate, technology for extending the bandwidth which has been developed, and a unit carrier that may be owned by a communication UE for such bandwidth extension is called a CC (component carrier). Accordingly, a scheme for aggregating multiple CCs is disclosed.

In other words, a plurality of conventional CCs may be aggregated and used. For example, 5 CCs may be aggregated and extended to produce a bandwidth having a maximum of 100 MHz. Technology for aggregating a plurality of CCs as described above is called Carrier Aggregation (CA). Frequency bands to which CCs may be allocated may or may not be contiguous.

A primary cell (PCell) for a UE refers to one serving cell which is always in activation state. When CA is configured, at least one serving cell together with the PCell, the at least one cell is called a secondary cell (SCell). The aggregation of serving cells based on the capabilities of the UE. The SCell may be variably allocated according to the amount of data to be transmitted or other conditions; however, the number of the SCells is not limited in the present invention.

In the embodiment, the UE is served by multiple serving cells, wherein the serving cells include a PCell and at least one SCell. When the periodic SRS is configured by an upper layer, the UE would transmit the periodic SRS on per activated serving cell periodically. However, when the UE is not in active time, the UE would drop the periodic SRS to be transmitted.

In 3GPP LTE system, a Downlink Control Information (DCI) message is generated and transmitted over a PDCCH. When the UE need to monitor the PDCCH, blind decoding is performed to decode the PDCCH in a given subframe. Multiple PDCCHs can be transmitted in a subframe thus the UE must monitor the plurality of PDCCHs in given subframe.

The DCI message transmits uplink or downlink scheduling information or other control data. In the embodiment, a SRS request may be transmitted through a PDCCH with a specific DCI format to trigger an aperiodic SRS, wherein the specific DCI format is such as DCI format 0 or DCI format 4, however, the present invention is not limiting the DCI format.

Since the DRX cycle is configured, the UE shall monitor the PDCCHs of activated serving cells during the active time. When a SRS request is transmitted through at least one PDCCH in a subframe, the UE is triggered to report the aperiodic SRS and then reports the aperiodic SRS in the next available subframe which is configured to transmit aperiodic SRS.

In the present embodiment, if the SRS request is transmitted through a PDCCH scheduling a specific serving cell, the aperiodic SRS would be transmitted on the specific serving cell. In the preferred embodiment, if UE is in a multiple serving cell environment, such as a primary cell and at least one secondary cell, the UE may receive a SRS request which is transmitted through a PDCCH scheduling a specific serving cell. Specially, the received SRS request may be used for triggering an aperiodic SRS of the specific serving cell or triggering an aperiodic SRS of other serving cells instead of the specific serving cell. If the received SRS request is for primary cell, the aperiodic SRS would be transmitted on the primary cell. Thus, the present invention is not limiting that a serving cell which the SRS request is received on is the same as a serving cell which the aperiodic SRS is transmitted on. However, if the aperiodic SRS and the periodic SRS transmissions occur in the same subframe for the same serving cell, the UE only transmits the aperiodic SRS.

In 3GPP E-UTRA system, the periodic SRS is type-O-triggered SRS and the aperiodic SRS is type-1-triggered SRS.

### The Third Embodiment

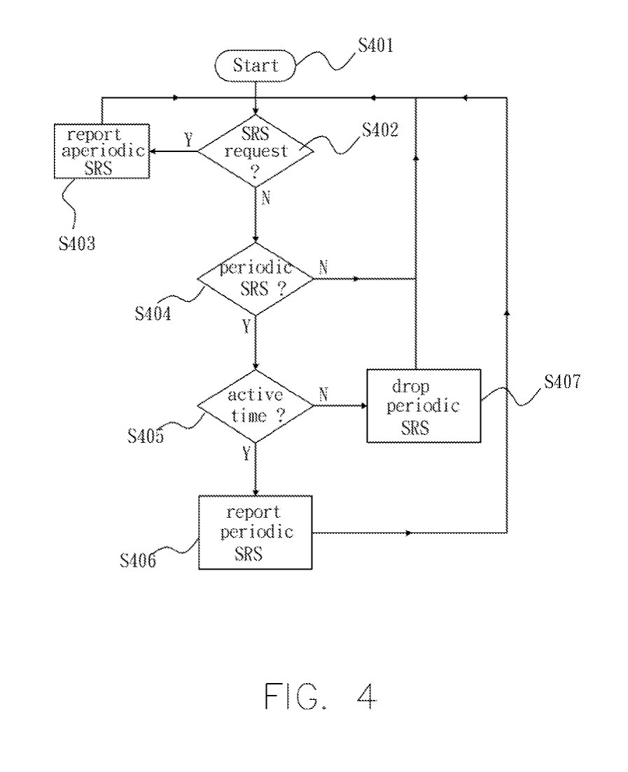

One method for reporting SRS in discontinuous reception can be summarized in accordance with the first embodiment shown in FIG. 4. FIG. 4 illustrates a flowchart depicting the method for reporting SRS in discontinuous reception according to third embodiment of the present invention. Referring to FIG. 4, the method includes the steps of:

In step S401, the method starts.

In step S402, it is determined whether a SRS request is received or not. In the above-mentioned embodiment, the SRS request can be transmitted through the PDCCH with a DCI format. When the SRS request is received, go to step S403. When the SRS request is not received, go to step S404.

In step S403, a SRS is transmitted. When the step S403 is performed, go back to the step S402. If the UE is in a non-active time, the transmitted SRS would be an aperiodic SRS.

In step S404, it is determined whether the periodic SRS is needed to be transmitted. If the periodic SRS is needed to be transmitted, go to step S405. If the periodic SRS is not needed to be transmitted, go back to step S402.

In step S405, it is determined whether the UE is in the active time. If the UE is in the active time, perform the step S406. If the UE is not in the active time, go to the step S407.

In the step S406, a periodic SRS is reported by the UE. When the step S406 is performed, go back to the step S402.

In the step S407, the periodic SRS to be transmitted is dropped by the UE. When the step S407 is performed, go back to step S402.

In the abovementioned steps, when the UE is in an active time and the aperiodic SRS and the periodic SRS transmissions occur in the same subframe, the transmitted SRS is only the aperiodic SRS.

### The Fourth Embodiment

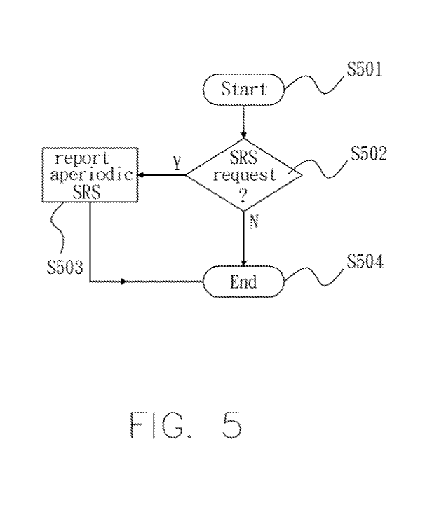

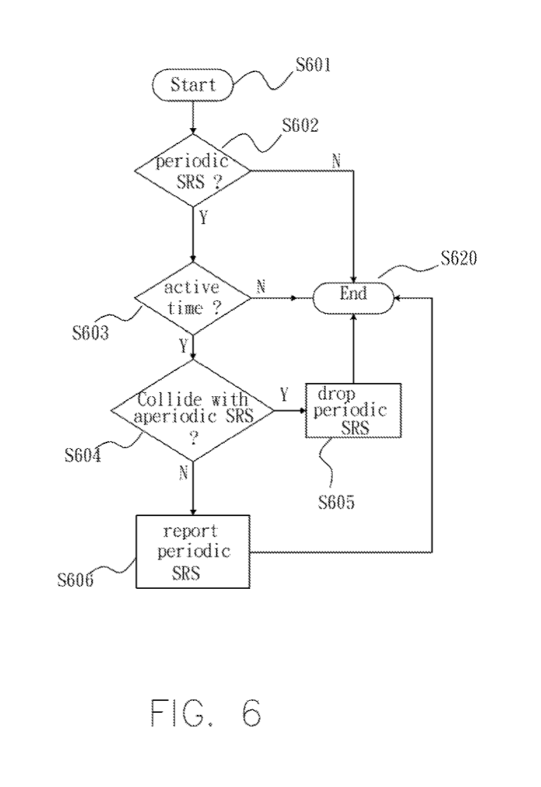

Another method for reporting SRS in discontinuous reception can be summarized in accordance with the first embodiment shown in FIGS. 5 and 6. FIG. 5 illustrates a flowchart depicting the method for reporting aperiodic SRS in discontinuous reception according to fourth embodiment of the present invention. FIG. 6 illustrates a flowchart depicting the method for reporting periodic SRS in discontinuous reception according to fourth embodiment of the present invention. Please referring to FIG. 5 first, the method for reporting aperiodic SRS includes the steps of:

In step S501, the method for reporting aperiodic SRS starts.

In step S502, it is determined whether a SRS request is received or not. When the SRS request is received, go to step S503. When the SRS request is not received, go to step S504.

In step S503, an aperiodic SRS is transmitted by the UE. In the embodiment, the UE reports the aperiodic SRS regardless of whether the UE is in active time or not. When the step S503 is performed, go back to the step S504.

In step S504, the method for reporting aperiodic SRS ends.

Please referring to FIG. 6, the method for reporting periodic SRS includes the steps of:

In step S601, the method for reporting periodic SRS starts.

In step S602, it is determined whether the periodic SRS is needed to be transmitted. If the periodic SRS is needed to be transmitted, go to step S603. If the periodic SRS is not needed to be transmitted, go to step S620.

In step S603, it is determined whether the UE is in the active time. If the UE is in the active time, perform the step S604. If the UE is not in the active time, go to the step S620.

In step S604, it is determined whether the aperiodic SRS and the periodic SRS transmissions occur in the same subframe in the serving cell. If the determination is positive, go to step S605. If the determination is negative, go to step S606.

In step S605, the periodic SRS which is needed to be transmitted is dropped. When the step S605 is performed, go back to the step S620.

In step S606, a periodic SRS is reported by the UE. When the step S606 is performed, go back to the step S620.

In step S620, the method for reporting periodic SRS ends.

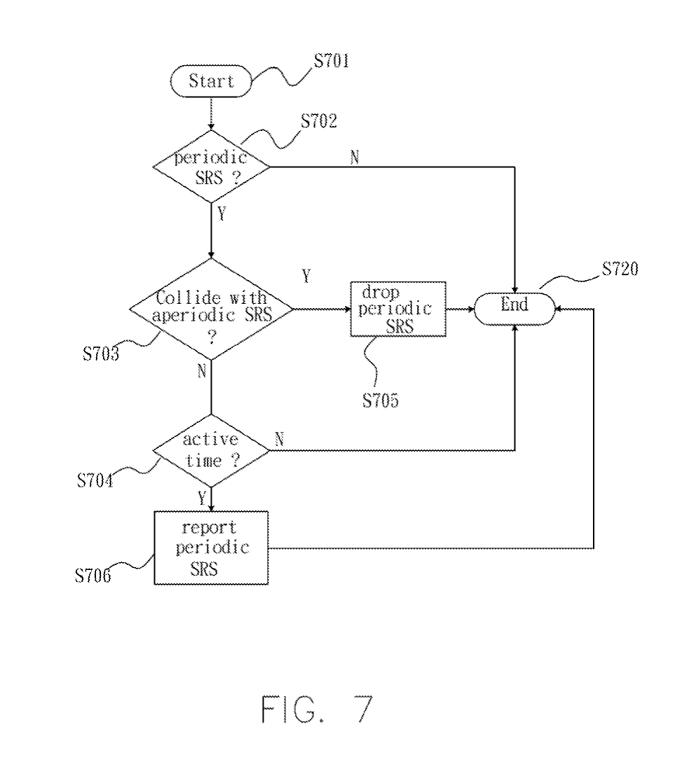

In the embodiment, the steps S603 and S604 can be switched and the complete flowchart is depicted in FIG. 7. FIG. 7 illustrates a flowchart depicting the method for reporting periodic SRS in discontinuous reception according to fourth embodiment of the present invention. Referring to FIG. 7, the steps S701-S706 and S720 are the same as the steps S601-S606 and S620 in FIG. 6, and the description is omitted. The difference between FIGS. 6 and 7 is the performing sequence of the steps S703 and S704, and the performing sequence of the step S705 is revised, accordingly.

The methods for reporting periodic and aperiodic SRS in discontinuous reception in FIGS. 4, 5, 6, and 7 is only concerned about one serving sell. When the CA is introduced in the embodiment according to the second embodiment, the UE performing the periodic SRS and the aperiodic SRS transmissions on one serving cell is similar to that on per activated serving cell. Specially, the aperiodic SRS is reported on a specific serving cell of multiple serving cells when the UE has been triggered to report the aperiodic SRS for the specific serving cell. In other words, the aperiodic SRS is reported on an i^{th} serving cell if the UE has received the SRS request on the i^{th} serving cell for triggering the aperiodic SRS for the i^{th} serving cell. In a preferred embodiment, the aperiodic SRS can be reported on a k^{th} serving cell if the UE has received the SRS request on the i^{th} serving cell for triggering the aperiodic SRS for the k^{th} serving cell.

In summary, since the aperiodic SRS transmission is permitted to report in both active time and non-active time, the base station (eNB) can obtain instantaneous channel condition and estimate channel more precisely. Also, the network can allocate the radio resource accordingly and appropriately.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A wireless communication system, comprising:
a user equipment (UE), for transmitting a periodic Sounding Reference Signal (SRS) and an aperiodic SRS, wherein the UE monitors a Physical Downlink Control Channel (PDCCH) in an active time;
a serving cell, having a serving range, wherein the UE is in the serving range of the serving cell; and
a base station, for performing connection to the UE and serving the serving cell;
wherein the UE transmits the aperiodic SRS when the UE is not in the active time and the UE has been triggered to report the aperiodic SRS by a SRS request from the basic station.

2. The wireless communication system according to claim 1, wherein the SRS request is transmitted through the PDCCH with a DCI format.

3. The wireless communication system according to claim 1, wherein the periodic SRS is dropped to transmit by the UE when the UE is not in the active time.

4. The wireless communication system according to claim 1, wherein the UE transmits the aperiodic SRS when the UE is in the active time and the UE has been triggered to report the aperiodic SRS.

5. The wireless communication system according to claim 1, wherein the UE only transmits the aperiodic SRS when both the aperiodic SRS and the periodic SRS transmissions occur in the same subframe in the same serving cell.

6. The wireless communication system according to claim 1, wherein the active time comprises:
a time when an onDurationTimer is running wherein the onDurationTimer specifies the number of consecutive PDCCH-subframe(s) at the beginning of a discontinuous reception (DRX) Cycle; or
a time when a drx-InactivityTimer is running wherein the drx-InactivityTimer specifies the number of consecutive PDCCH-subframe(s) after successfully decoding a PDCCH indicating an initial uplink or downlink user data transmission for the corresponding user equipment thereof; or
a time when a drx-RetransmissionTimer is running, wherein the drx-RetransmissionTimer specifies the maximum number of consecutive PDCCH-subframe(s) for as soon as a downlink retransmission is expected by the corresponding user equipment thereof.

7. The wireless communication system according to claim 1, wherein the active time comprises:
a time when a mac-ContentionResolutionTimer is running,
wherein the mac-ContentionResolutionTimer specifies the number of consecutive subframe(s) during which the corresponding user equipment thereof shall monitor the PDCCH after a Msg3 is transmitted and
wherein the Msg3 specifies a message transmitted on UL-SCH containing a C-RNTI MAC CE or CCCH SDU, submitted from upper layer and associated with the UE Contention Resolution Identity, as part of a random access procedure.

8. The wireless communication system according to claim 1, wherein the active time comprises:
a time when a Scheduling Request is sent on a physical uplink control channel (PUCCH) and is pending; or
a time when an uplink grant for a pending HARQ retransmission can occur and there is data in the corresponding HARQ buffer; or
a time when PDCCH indicating a new transmission addressed to the C-RNTI of the UE has not been received after successful reception of a Random Access Response for the preamble not selected by the corresponding user equipment thereof.

9. The wireless communication system according to claim 1, wherein the serving cell is a primary cell and the wireless communication system further comprises a secondary cell, and the UE reports the aperiodic SRS through the primary cell if UE has been triggered to report the aperiodic SRS for the primary cell; and the UE reports the aperiodic SRS through the secondary cell if UE has been triggered to report the aperiodic SRS for the secondary cell.

10. The wireless communication system according to claim 1, wherein the communication system further comprises M serving cells, and the UE reports the aperiodic SRS on a i^{th} serving cell if the UE has received the SRS request on the i^{th} serving cell for triggering the aperiodic SRS for i^{th} serving cell; and
the UE reports the aperiodic SRS on k^{th} serving cell if the UE has received the SRS request on the i^{th} serving cell for triggering the aperiodic SRS for k^{th} serving cell, wherein, i, k and M are nature numbers and i and k are smaller than or equal to M.

11. The wireless communication system according to claim 1, wherein the wireless communication system is applied to a 3rd Generation Partnership Project (3GPP) Evolved UTRA (E-UTRA) system, the periodic SRS is type-O-triggered SRS and the aperiodic SRS is type-1-triggered SRS.

12. A method for reporting SRS in discontinuous reception, comprising:
providing a user equipment (UE) for transmitting a periodic Sounding Reference Signal (SRS) and an aperiodic SRS;
transmitting the periodic SRS by the UE when the UE is in a serving range of a serving cell;
monitoring a Physical Downlink Control Channel (PDCCH) of the serving cell by the UE when the UE is in a active time;
transmitting a SRS request for triggering the UE to report the aperiodic SRS; and
reporting the aperiodic SRS when the UE is not in the active time and the UE has been triggered to report the aperiodic SRS.

13. The method for reporting SRS in discontinuous reception according to claim 12, further comprising:
when the UE is not in active time, dropping the periodic SRS to be transmitted by the UE.

14. The method for reporting SRS in discontinuous reception according to claim 12, wherein the SRS request is transmitted through the PDCCH with a DCI format.

15. The method for reporting SRS in discontinuous reception according to claim 12, further comprising:
reporting the aperiodic SRS by the UE when the UE is in the active time and the UE has been triggered to report the aperiodic SRS.

16. The method for reporting SRS in discontinuous reception according to claim 12, further comprising:
performing a radio resource allocation according to the periodic SRS and the aperiodic SRS.

17. The method for reporting SRS in discontinuous reception according to claim 12, further comprising:
only transmitting the aperiodic SRS when both the aperiodic SRS and the periodic SRS transmissions occur in the same subframe in the same serving cell.

18. The method for reporting SRS in discontinuous reception according to claim 12, wherein the serving cell is a primary cell, the UE is further served by a secondary cell and the secondary cell is activated, the method further comprising:
reporting the aperiodic SRS on the primary cell if the UE has been triggered to report the aperiodic SRS for the primary cell; and
reporting the aperiodic SRS on the secondary cell if the UE has been triggered to report the aperiodic SRS for the secondary cell.

19. The method for reporting SRS in discontinuous reception according to claim 12, further comprising:
providing M serving cells for serving the UE;
reporting the aperiodic SRS on an i^{th} serving cell if the UE has received the SRS request on the i^{th} serving cell for triggering the aperiodic SRS for the i^{th} serving cell; and
reporting the aperiodic SRS on a k^{th} serving cell if the UE has received the SRS request on the i^{th} serving cell for triggering the aperiodic SRS for the k^{th} serving cell,
wherein, i, k and M are nature numbers and i and k are smaller than or equal to M.

20. The method for reporting SRS in discontinuous reception according to claim 12, wherein the active time comprises:
a time when an onDurationTimer is running wherein the onDurationTimer specifies the number of consecutive PDCCH-subframe(s) at the beginning of a discontinuous reception (DRX) Cycle; or
a time when a drx-InactivityTimer is running wherein the drx-InactivityTimer specifies the number of consecutive PDCCH-subframe(s) after successfully decoding a PDCCH indicating an initial uplink or downlink user data transmission for the corresponding user equipment thereof; or
a time when a drx-RetransmissionTimer is running wherein the drx-RetransmissionTimer specifies the maximum number of consecutive PDCCH-subframe(s) for as soon as a downlink retransmission is expected by the corresponding user equipment thereof.

21. The method for reporting SRS in discontinuous reception according to claim 12, wherein the active time comprises:
a time when a mac-ContentionResolutionTimer is running,
wherein the mac-ContentionResolutionTimer specifies the number of consecutive subframe(s) during which the corresponding user equipment thereof shall monitor the physical downlink control channel (PDCCH) after a Msg3 is transmitted
wherein the Msg3 specifies a message transmitted on UL-SCH containing a C-RNTI MAC CE or CCCH SDU, submitted from upper layer and associated with the UE Contention Resolution Identity, as part of a random access procedure.

22. The method for reporting SRS in discontinuous reception according to claim 12, wherein the active time comprises:
a time when a Scheduling Request is sent on a physical uplink control channel (PUCCH) and is pending; or
a time when an uplink grant for a pending HARQ retransmission can occur and there is data in the corresponding HARQ buffer; or
a time when PDCCH indicating a new transmission addressed to the C-RNTI of the UE has not been received after successful reception of a Random Access Response for the preamble not selected by the corresponding user equipment thereof.

23. The method for reporting SRS in discontinuous reception according to claim 12, wherein the method is applied to a 3rd Generation Partnership Project (3GPP) Evolved UTRA (E-UTRA) system, the periodic SRS is type-0-triggered SRS and the aperiodic SRS is type-1-triggered SRS.
